(19) United States
(12) Patent Application Publication
(10) Pub. No.: US 2017/0304933 A1
(43) Pub. Date: Oct. 26, 2017

(54) FRICTION STIR ADDITIVE PROCESSING AND METHODS THEREOF

(71) Applicant: BRIGHAM YOUNG UNIVERSITY, Provo, UT (US)

(72) Inventors: Michael P. MILES, Springville, UT (US); Tracy W. NELSON, Springville, UT (US)

(21) Appl. No.: 15/493,086

(22) Filed: Apr. 20, 2017

Related U.S. Application Data
(60) Provisional application No. 62/325,027, filed on Apr. 20, 2016.

(51) Int. Cl. B23K 20/12; B23K 20/24

(52) U.S. Cl. CPC B23K 20/128; B23K 20/24

(57) ABSTRACT

In a general aspect, a method includes filling at least a portion of a cavity of a component with an additive material, and mixing, using a friction stir tool, a material of the component with the additive material. The additive material may be a liquid metal or a solid metal.

### CROSS REFERENCE TO RELATED APPLICATION

This application is a Non-provisional of, and claims to priority to, U.S. Provisional Application No. 62/325,027, entitled: “Friction Stir Additive,” filed on Apr. 20, 2016, which is hereby incorporated in its entirety.

### GOVERNMENT RIGHTS

This invention was made with government support under Grant Number 1405508 awarded by the National Science Foundation. The government has certain rights in the invention

### TECHNICAL FIELD

Example embodiments relate to methods for repairing a damaged portion of a component.

### BACKGROUND

Defects (e.g., cracks, voids, etc.) in existing metal components are often difficult to repair using traditional fusion welding methods. One method of repairing the defects can be friction welding in which heat through mechanical friction between the different components causes materials of the components to plastically displace and bond together.

### SUMMARY

In a general aspect, a method includes filling at least a portion of a cavity of a component with an additive material, and mixing, using a friction stir tool, a material of the component with the additive material. The additive material may be applied as liquid metal or a solid metal.

Implementations can include one or more of the following features. For example, filling the cavity with the additive material may be performed by at least one of metal inert gas welding, tungsten inert gas welding, laser deposition, powder deposition, and powder infiltration. In some implementations, the mixing of the material of the component and the additive material may be performed around a perimeter of the cavity.

In still another general aspect, the method may further include removing a portion of the component to define the cavity. In some implementations, the removal of the portion of the component may be performed prior to filling the cavity with the additive material.

In another general aspect, a method includes removing a portion of a component to define a cavity within the component, filling at least the portion of the cavity of the component with an additive material, and mixing a material of the component with the additive material by using a friction stir tool.

In another general aspect, a product includes an additive material filled in a cavity of a component, and a mixture, composed of a material of the component and the additive material, formed around a perimeter of the cavity. The additive material including at least one of a liquid metal or a solid metal.

### BRIEF DESCRIPTION OF THE DRAWINGS

FIG. 1 is a flowchart illustrating a method according to at least one example embodiment.

FIG. 2 is a flowchart illustrating a method according to another example embodiment.

FIGS. 3A-3I are cross-sectional views illustrating a method according to at least one example embodiment.

FIGS. 4A-4H are cross-sectional views illustrating a method according to another example embodiment.

FIG. 5 is a schematic drawing of a friction stir tool according to at least one example embodiment.

FIG. 6 is a schematic drawing of a fine grain microstructure of an additive material according to at least one example embodiment.

FIGS. 7A-7C are schematic drawings associated with fine grain microstructure according to at least one example embodiment.

### DETAILED DESCRIPTION OF EXAMPLE EMBODIMENTS

While example embodiments may include various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the claims. Furthermore, the figures are intended to illustrate the general characteristics of methods and/or structure utilized in certain example embodiments and to supplement the written description provided below. These figures are not, however, to scale and may not precisely reflect the precise structural or performance characteristics of any given embodiment, and should not be interpreted as defining or limiting the range of values or properties encompassed by example embodiments. For example, the structural elements may be reduced or exaggerated for clarity. The use of similar or identical reference numbers in the various drawings is intended to indicate the presence of a similar or identical element or feature.

Friction stir processing (FSP) (developed based on the basic principles of friction stir welding (FSW)) can be a solid-state joining process originally developed for aluminum alloys. FSP can be a metalworking technique that can provide localized modification and control of microstructures in near-surface layers of processed metallic components. FSP can cause intense plastic deformation, material mixing, and thermal exposure, resulting in significant microstructural refinement, densification, and homogeneity of the processed zone. The FSP technique has been successfully used for producing a fine-grained structure and surface composite, modifying the microstructure of materials, and synthesizing the component and intermetallic compound in-situ (i.e., at a time of processing the region).

In some implementations, FSP may be a processing region repair method for, for example, stainless steel. In FSP, a friction stir processing tool processes around the component including a defect (e.g., crack), and mixes the material, which softens a base material of the component caused by frictional heat generated between the friction stir processing tool and the base material. Additionally, FSP may create plastic flow through the stirring of the softened portion with the friction stir processing tool.

In implementations described herein, additive manufacturing methods can be used to deposit metallic material onto a component. Deposits prepared using additive manufacturing techniques can have bond strengths superior to those of thermally sprayed coatings, and can have the potential to enhance corrosion resistance, enhance wear resistance, repair damaged or worn surfaces, and act as an interfacial layer for bonding metal matrix composites. In some implementations, the additive manufacturing technique may be a process in which metal may be injected into an energy source under tightly controlled atmospheric conditions. The energy source may melt the surface of the target material and may generate a small molten pool of material (i.e., filler material). The resulting filler material may then be used to build or repair metal parts for a variety of different applications.

Example embodiments can include methods for combining FSP and additive manufacturing methods to repair defects (e.g., cracks, voids, etc.) in a component. In some implementations, the method may achieve a desired set of properties of (in part) the component.

In at least some implementations, the method can be used to repair the crack or other defects by first removing material surrounding the defect by machining or other material removal process, which creates a cavity (e.g., hole, opening, groove, channel, trench, etc.). Removing the material around the defect area in the component avoids the potential for, for example, oxide, or some other contaminant, to mix into the base metal during the repair. Oxide or some other contaminant may be present if the crack or other defect has oxidized over time.

In some implementations, after removal of material to define a cavity, the cavity may be filled with an additive material via an additive manufacturing process. In some implementations, the additive manufacturing process may be, or can include, metal inert gas (MIG) welding, tungsten inert gas (TIG) welding, and/or laser deposition. In some implementations, a variety of processes for melting the additive material could be used to fill the cavity.

In some implementations, after filling the cavity with the additive material, a friction stir tool may be used to process in and/or around the filled area in the cavity. This can homogenize the additive material and the base material, refine the grain size, and/or create a defect free repair volume. The additive material could be the same, or different, than the base material, depending on the desired properties of the repaired component.

Example embodiments can include a method for repairing a defect (i.e., crack) in a component. In some implementations, the method may include removing a portion of a component by, for example, machining. Removing a portion of the component creates a cavity in the component. In some implementations, the method may include filling the cavity using an additive manufacturing process.

Example embodiments can include a method for repairing a defect in a component. In some implementations, the method may include covering or partially filling a defect, such as a crack, using an additive manufacturing method without first removing a portion of the component, i.e., a volume of material to be repaired.

Example embodiments relate to a method for creating a special set of engineering properties on a surface of a component. In some implementation, the method may be used to create desired engineering properties by mixing different alloys via FSP. In some implementations, the method may include removing a portion of a component. For example, the removed portion may be a notch or a set of notches, a hole or series of holes, a cavity or some other shape. In some implementations, removal of the portion may be accomplished by machining or other methods. In some implementations, the removed portion may include, but does not necessarily include, an area to be repaired. The desired properties may be used for, for example, an engineering purpose.

In some implementations, the additive manufacturing process may be metal inert gas (MIG) welding, tungsten inert gas (TIG) welding, a laser deposition, powder deposition and/or powder infiltration, or any other method for filling a cavity with a liquid metal or a solid metal. In some implementations, the material used to fill the cavity is the same composition as the material removed from the component. In some implementations, the material used to fill the cavity is a different composition from the material removed. Using a different composition can enable the repair to have desired properties. In some implementations, the method may include mixing the filled material with the material of the composition with a friction stir processing tool. Using the friction stir processing tool over (e.g., within) the filled cavity may refine the grain structure, mix the repaired filled material and the material of the composition, and create target microstructures based on the thermal history of the processing step. For example, different feeds and/or speeds could be used to create higher or lower processing temperatures. In some implementations, the method may include mixing the filled material with the material of the composition with a friction stir processing tool to process around the repaired area.

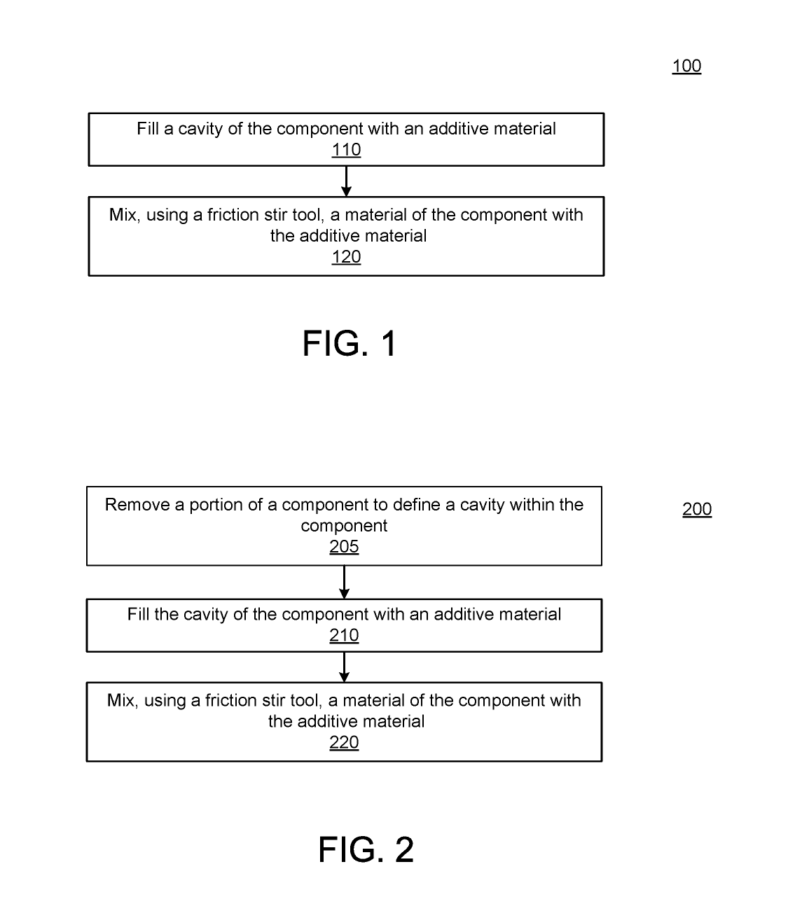

FIG. 1 illustrates a flowchart of an example method 100 according to an implementation. The method 100 includes, in block 110 filling at least a portion of a cavity of a component with an additive material, and, in block 120 mixing a material of the component with the additive material using a friction stir tool.

In some implementations, the additive material may be a liquid metal or a solid metal. In some implementations, materials that may serve as the additive material may include metals and metallic materials, polymers and polymeric materials, ceramic and other reinforcing materials, as well as combinations of these materials. In some implementations, the additive material may be a composite material including at least one metallic material and at least one polymeric material.

In some embodiments, the additive material may be of a similar or dissimilar material as that of the material of the component. For example, the additive material and the material of the component may include metallic material, and without limitation include metal-metal combinations, metal matrix composites, polymers, polymer matrix composites, polymer-polymer combinations, metal-polymer combinations, metal-ceramic combinations, and polymer-ceramic combinations.

In some implementations, the additive material may be selected from, or can include, any metal, including for example steel, aluminum (Al), nickel (Ni), chromium (Cr), copper (Cu), Cobalt (Co), gold (Au), silver (Ag), magnesium (Mg), cadmium (Cd), tin (Sn), palladium (Pd), platinum (Pt), Titanium (Ti), zinc (Zn), iron (Fe), Niobium (Nb), Tantalum (Ta), molybdenum (Mo), tungsten (W), or an alloy including one or more of these metals.

Non-limiting examples of polymeric materials may include polyolefins, polyesters, nylons, vinyls, polyvinyls, acrylics, polyacrylics, polycarbonates, polystyrenes, polyurethanes, and the like.

Non-limiting examples of ceramic materials may include carbide, boride, nitride, and oxide, and the like.

In some implementations, the additive material can have different material properties as compared to the material of the component. For example, the additive material may have a difference in melting temperature, density, and/or hardness of up to about 50% of the material of the component. In some implementations, the difference in hardness may be from 2-20%. In some implementations, the difference in hardness may be at least about 10%. In some implementations, the additive material may have a lower melting temperature and/or less dense or lighter properties than the material of the component.

In block 110, the additive material may be filled in the cavity by an additive manufacturing process. In some implementations, the additive manufacturing process may be a process of depositing (via, for example, melting the material or inserting a solid material) additive material into the cavity. In some implementations, the additive manufacturing process may be metal inert gas (MIG) welding, tungsten inert gas (TIG) welding, laser deposition, powder deposition and/or powder infiltration.

Other additive processes could be used to fill the cavity. For example, other welding processes can be, such as but not limited to, arc welding (e.g., shielded metal arc welding, submerged arc welding, electroslag welding, and plasma arc welding), gas welding (e.g., oxyacetylene welding, oxyhydrogen welding, and pressure gas welding), solid state welding (e.g., forge welding, cold welding, friction welding, explosive welding, diffusion welding, and ultrasonic welding), thermit welding, and electron beam welding.

In some implementations, the additive material may be in powder form or a solid piece (i.e., solid bar). In some implementations, the solid piece may have similar volume (e.g., size) or dimension(s) as the cavity to fit within the cavity.

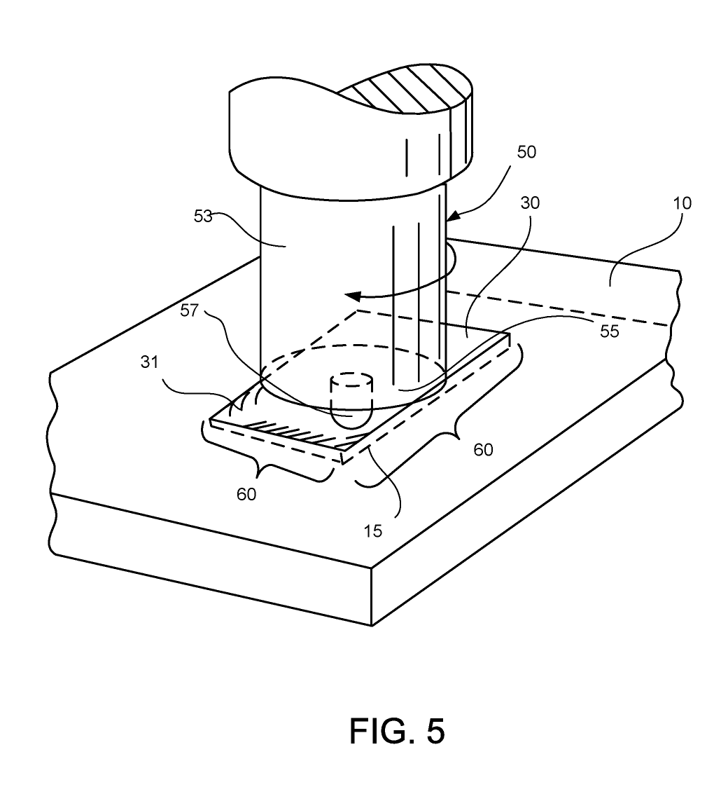

In block 120, once the cavity is filled, the additive material in the cavity may be mixed using a friction stir tool 50 (as shown and described in connection with FIG. 5) to homogenize the additive material and a material of the component. This imparts sufficient interfacial adhesion such that friction stir processing (FSP) does not delaminate the additive material from the material of the component.

FSP may be used for a solid state joining of the additive material and the material of the component by frictional heating. In some implementations, FSP may join the additive material and the material of the component through cyclical movements of a tool piece that is harder than the additive material. Frictional heat produced between the additive material and the friction stir tool during the process causes the additive material to soften, and structural intermixing and pressure cause the additive material to join the materials.

Further, FSP may use shear-induced interfacial heating and plastic deformation to deposit metallic materials into the additive material. FSP can join materials so that they have bond strengths superior to those of other technique, such as, thermally sprayed coatings, and have the potential to enhance corrosion resistance, enhance wear resistance, repair damaged or worn surfaces, and act as an interfacial layer for bonding metal matrix composites. The mechanical shearing that occurs at the interface acts to disperse any oxides or boundary layers, resulting in a metallurgical bond between the additive material and the material of the component.

As shown in FIG. 5, for example, in some implementations, a friction stir tool 50 may include a pin 57 (e.g., rotating pin) to press an additive material 30 and a component 10 with sufficient force to be joined until a shoulder 55 of the friction stir tool that surrounds the pin 57 is positioned against the surface of the additive material 30 and/or the material of the component 10.

The pin 57 remains at the pressed location, while rotating, for a predetermined period, wherein the region between the shoulder 55 of the friction stir tool 50 and the additive material 30 is heated to just under a melting point of the component. The additive material 30 and the material of the component 10 then soften and plasticize so as to mix the additive material 30 and the material of the component 10.

Then the friction stir tool 50 is moved in an advancing direction (within or around a boundary of the cavity) such that the shoulder 55 continues to be pressed with great force against the additive material 30 and/or the material of the component 10, and the pin 57 is thus pressed into the joining region. During the advancing movement, the rotational movement of the pin 57 creates a pressure difference between the forward region of the friction stir tool 50 and its back side so that plasticized material is moved about the pin 57, mixes, and thus contributes to form a bonded, consolidated region (e.g., weld). The friction stir tool 50, and components thereof, is described in connection with several of the figures below.

Referring back to FIG. 1, in some implementations, the mixing of the material of the component and the additive material may be performed around a perimeter of the cavity (e.g., along a sidewall of the cavity). In some implementations, the mixing of the material of the component and the additive material may occur on sidewalls of the cavity. In some implementations, the mixing of the material of the component and the additive material around the perimeter of the cavity can be performed at a sidewall interface between the additive material and the component.

In some implementations, the mixing of the material of the component and the additive material may occur on a bottom surface (e.g., wall) of the cavity. In other words, the mixing of the material of the component and the additive material may be performed along a bottom surface of the cavity. In some implementations, the mixing of the material of the component and the additive material along the bottom surface of the cavity can be performed at a bottom surface interface between the additive material and the component.

FIG. 2 is a flowchart illustrating a method according to another example embodiment. As shown in FIG. 2 the method 200 may include, in block 205 removing a portion of a component to define a cavity within the component, in block 210 filling at least the portion of the cavity of the component with an additive material, and in block 220 mixing a material of the component with the additive material by using a friction stir tool. Similarly features as described in FIG. 1 will not be discussed in this section. For instance, block 210 and block 220 in FIG. 2 are similar to, or the same as, block 110 and 120 in FIG. 1, respectively.

In block 205, a portion of material in the component around (e.g., near, adjacent) the defect is removed to create a cavity. Because oxide or other contaminants, may be present, removal of the material in and/or around the defect area in the component avoids the potential for oxide or other contaminants to mix into the base metal (i.e., material of the component) during the repair.

In some implementation, the removal of the portion of the component may be performed prior to, in block 210 filing the cavity with the additive material. This can ensure that all contaminates (i.e., oxidized materials) have been removed.

In some implementation, the cavity may extend to a depth into the component at or above a depth of the defect. In some implementation, the cavity may extend to a depth into the component at or below a depth of the defect. In some implementations, the cavity can be sufficiently deep to extend below the defect extending into the component. In some implementations, the cavity can have a depth that is much greater than (e.g., two times greater than, three times greater than) a depth of the defect. In some implementations, the cavity can have a width and/or a length that is greater than (e.g., two times greater than, three times greater than) a width and/or a length of the defect. In some implementations, the cavity can have a volume that is greater than (e.g., two times greater than, three times greater than) a volume of the defect.

In some implementations, the cavity may be formed by machining. For example, types of machining may be, but not limited to, boring, cutting, drilling, grinding, milling, turning, laser cutting, oxy-fuel cutting, plasma cutting, water jet cutting, electric discharge machining (EDM), computer numerical control (CNC) machining, and precision machining.

In some implementations, the cavity may be a notch or a set of notches. For example, the notch can be a notch in a sidewall of a component. In some implementations, the cavity can be or can include a hole or series of holes. In some implementations, the cavity can be or can include some other shape such as a square (e.g., substantially square), a cube, a recess, a concave shape, rectangular (e.g., substantially rectangular), oval (e.g., substantially oval), circular (e.g., substantially circular), and/or so forth.

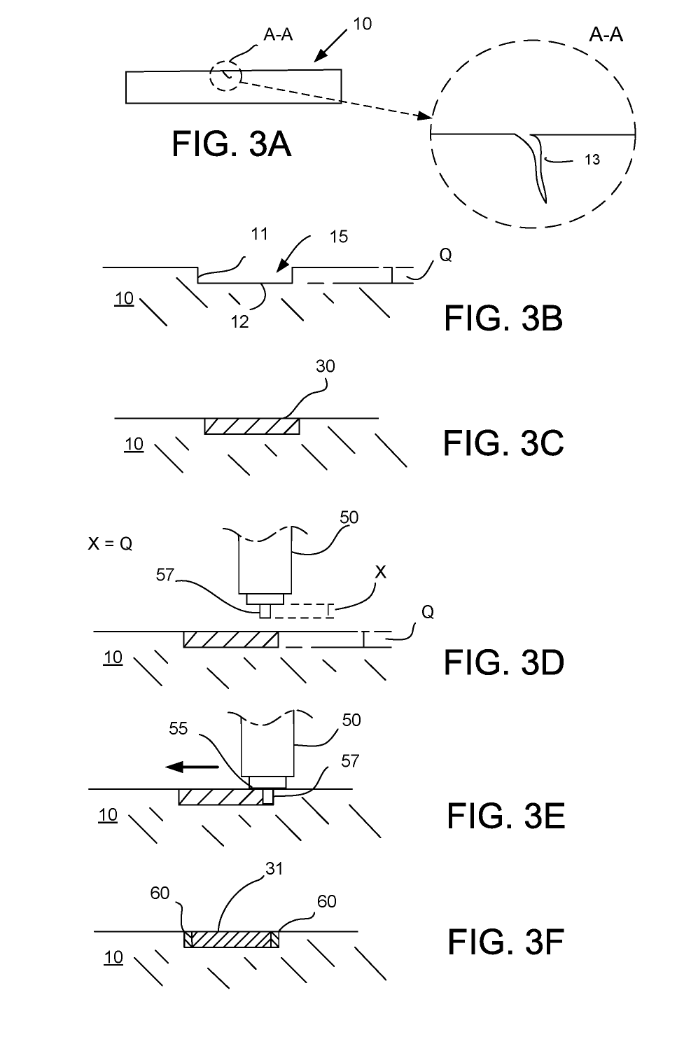

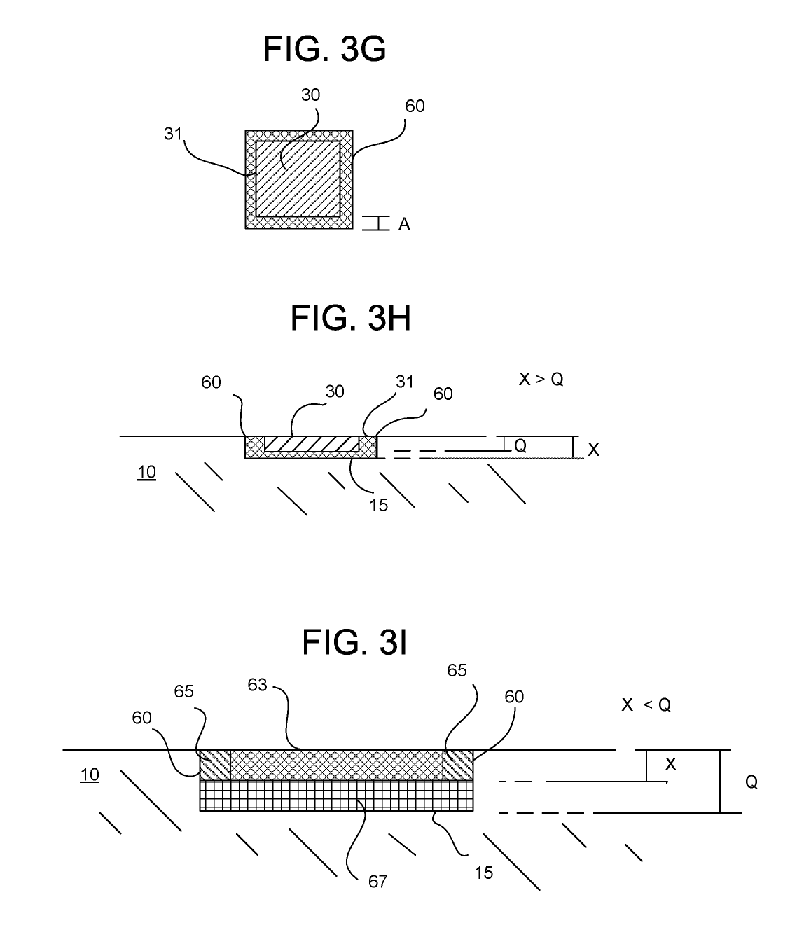

FIGS. 3A-3I illustrate a schematic of a method according to an example embodiment. FIG. 3A shows a component including a defect. FIG. 3B show removal of material of the component to define (e.g., form) a cavity. FIG. 3C shows a deposition of additive material onto the component. FIGS. 3D and 3E show the subsequent friction stir processing using a friction stir tool. FIG. 3F illustrates the deposited additive material after the friction stir processing. FIG. 3G is a top view of the deposited additive material as shown in FIG. 3F. FIGS. 3H and 3I illustrate a method according to an example embodiment.

Referring to FIG. 3A, the component 10 may include a defect 13. The component 10 may be any structural component made from, for example, a metallic material, a polymeric material, and/or so forth. The component 10 may be made from various metallic materials, polymeric materials, and/or so forth as described above.

The defect 13 in the component 10 can be caused, for example, after a long period of exposure to high temperature, high pressure, and/or high velocity, which may create stress in the material of the component. In some implementations, for example, structural components employed in a nuclear industry include components formed of metallic materials, e.g., stainless steel. These materials may be often exposed to very aggressive environments, in terms of heat, neutron bombardment, corrosion, and the like, which can lead to various levels of cyclic or steady stress. The resulting occurrence is often referred to as stress corrosion cracking or corrosion fatigue. Damage from stress corrosion cracking is of great issue, since material failure can be very unpredictable. Hence, stress corrosion cracking should be repaired.

Referring to FIG. 3B, a portion of material in the component 10 around the defect 13 may be removed to create a cavity 15. The cavity can have a sidewall 11 and a bottom surface 12. For example, if oxide or other contamination is present in and/or around the defect 13, removal of the material around the defect area in the component can avoid the potential for oxide or other contaminants to mix into the base metal (i.e., material of the component) during the repair.

In some implementations, the cavity 15 may include a depth Q (e.g., extending into the component 10). In some implementations, the depth Q of the cavity 15 may extend into the component 10, at or below a depth of the defect 13, and can define a trench. In other words, the depth Q of the cavity 15 can be sufficiently deep to extend below the deepest portion of the defect 13 extending into the component 10.

In some implementations, the size and/or shape (e.g., including the depth Q) of the cavity 15 can vary depending on the size, dimension parameters of the defect 13. In some implementations, the volume of the cavity 15 can exceed a volume of the defect 13. In some implementations, the cavity 15 can have any of the shapes described above. In some implementations, the cavity 15 may be formed by machining including any of the machining described above.

FIG. 3C shows a deposition of the additive material 30 in the cavity 15 of the component 10. In this step, in some implementations, the deposition of additive material 30 may be melted to fuse the additive material 30 to the material of the component 10.

In some implementations, the additive material 30 may be deposited in the cavity by an additive manufacturing process. For example, the additive manufacturing process may be, or can include, MIG welding, TIG welding, laser deposition, powder deposition and/or powder infiltration.

In some embodiments, the additive material 30 may be the same as the material of the component 10. In other words, a chemical composition of the additive material 30 may be the same as a chemical composition of the material of the component 10.

In some embodiments, the additive material 30 may be different than the material of the component 10. In other words, a chemical composition of the additive material 30 may be different from a chemical composition of the material of the component 10.

FIG. 3D shows the subsequent FSP used to ensure metallurgical bonding between the component 10 and the deposited additive material 30.

As shown in FIG. 3D, once an entire cross-sectional layer of additive material 30 is deposited in the cavity 15, the additive material 30 in the cavity 15 may be mixed. In some implementation, the mixing may be a FSP using a friction stir tool 50 to homogenize the deposited additive material 30 and promote interlayer adhesion with the material of the component 10. In addition, the FSP will refine the microstructure of the deposited additive material 30.

In some implementations, the friction stir tool 50 (which is also shown and described in connection with FIG. 5) may include a rotating pin 57 to press the deposited additive material 30 until a shoulder of the friction stir tool that surrounds the pin 57 is positioned against the surface of the additive material 30.

As shown in FIG. 3E, the pin 57 remains at the pressed location for a predetermined period, where the region between a shoulder 55 of the friction stir tool 50 and the additive material 30 is heated to just under a melting point of the component 10. The additive material 30 and the material of the component 10 then softens and plasticizes so as to mix the materials of the additive material 30 and the component 10.

The friction stir tool 50 may then be moved in an advancing direction (within or around a boundary of the cavity) such that the shoulder continues to be pressed against the additive material 30 and/or the material of the component 10, and the pin 57 is thus pressed into the joining region. During the advancing movement, the rotational movement of the pin 57 may create a pressure difference between the forward region of the friction stir tool 50 and its back side so that plasticized material is moved about the pin 57, mixes, and thus contributes to forming a consolidated, bonded region.

In some implementations, a depth of the pin 57 in the component 10 and/or the additive material 30 can vary depending on the depth Q of the cavity 15. In some implementations, the depth of the pin 57 in the additive material 30 and/or the component 10 may match the depth Q of the cavity 15. In some implementations, a length X of the pin 57 can be selected based on the depth Q of the cavity 15. For example, the length X of the pin 57 can be selected to be less than the depth Q of the cavity 15. In some implementations, the length X of the pin 57 can be selected to be equal to or greater than the depth Q of the cavity 15. In the implementation shown in FIG. 3E, the length C of the pin 57 is closely matched to the depth Q of the cavity 15.

As shown in FIG. 3F, around a perimeter 60 (i.e., sidewalls in the cavity) of the cavity 15, the materials of the additive material 30 and the material of the component 10 may be mixed. In some implementations, the mixing of the additive material 30 and the material of the component 10 may form a good adhesion property. Because there is a metallurgical bonding between the deposited additive material 30 and the component 10, a promotion of interlayer adhesion between the materials are provided.

Additionally, due to FSP, as shown in FIG. 3F, the microstructure of the deposited additive material 30 (around the perimeter of the cavity) has been refined or mixed into mixed additive material 31 (e.g., a homogenous mixture with a bond strength approaching the ultimate tensile strength of the material of the component 10).

FIG. 3G is a top view of FIG. 3F, which illustrates the deposited additive material 30 and the mixed additive material 31 surrounding the deposited additive material 30. In the implementation shown in FIG. 3G, the shape of the cavity 15 is substantially square. Other shapes may be employed, such as, for example, rectangular (e.g., substantially rectangular), oval (e.g., substantially oval), circular (e.g., substantially circular), and/or so forth.

As shown in FIG. 3G, the deposited additive material 30 (shown in FIG. 3E) around the perimeter 60 of the cavity 15 has been mixed with the material of the component 10, defining the mixed additive material 31. In some implementations, an area of the mixed additive material 31 is at least as thick as a width of the pin 57, defining a width A around the perimeter 60 of the cavity 15.

In some implementations, as shown in FIG. 3H, the mixing of the additive material 30 and the material of the component 10 may also occur at a bottom surface of the cavity 15. This can result when the pin 57 is longer than the depth Q of the cavity 15. In other words, when the length X of the pin 57 is greater than the depth Q of the cavity 15. Due to the pin 57 being longer than the depth Q, mixing of the additive material 30 with the material of the component 10 may be performed at the bottom surface of the cavity 15.

In some implementations, the additive material at the bottom surface of the cavity 15 may be mixed while the additive material at the sidewalls may be un-mixed. This may be caused when the friction stir tool 50 is away from the perimeter of the cavity 15.

In some implementations, as shown in FIG. 3I, the mixing of the additive material 30 and the material of the component 10 may occur at the sidewalls but not at a bottom surface of the cavity 15. In other words, the mixing of the additive material 30 occurs within some depth of the cavity 15 (i.e., prior to the bottom surface of the cavity 15). This may create a mixed additive material 63, a mixed additive material with the material of the component 65 (around the perimeter 60 of the cavity), and an un-mixed additive material 67. This can result when the pin 57 is shorter than the depth Q of the cavity 15. In other words, when the length X of the pin 57 is shorter than the depth Q of the cavity 15. Because the pin 57 may not reach the bottom surface of the cavity 15, there may be un-mixed additive material 67 around the bottom surface of the cavity.

In some implementations, a geometry (size and shape) of the pin 57 may be varied to modify the stirring (mixing) process. In some implementations, the pin 57 may be, for example, a threaded-tapered stirring configuration.

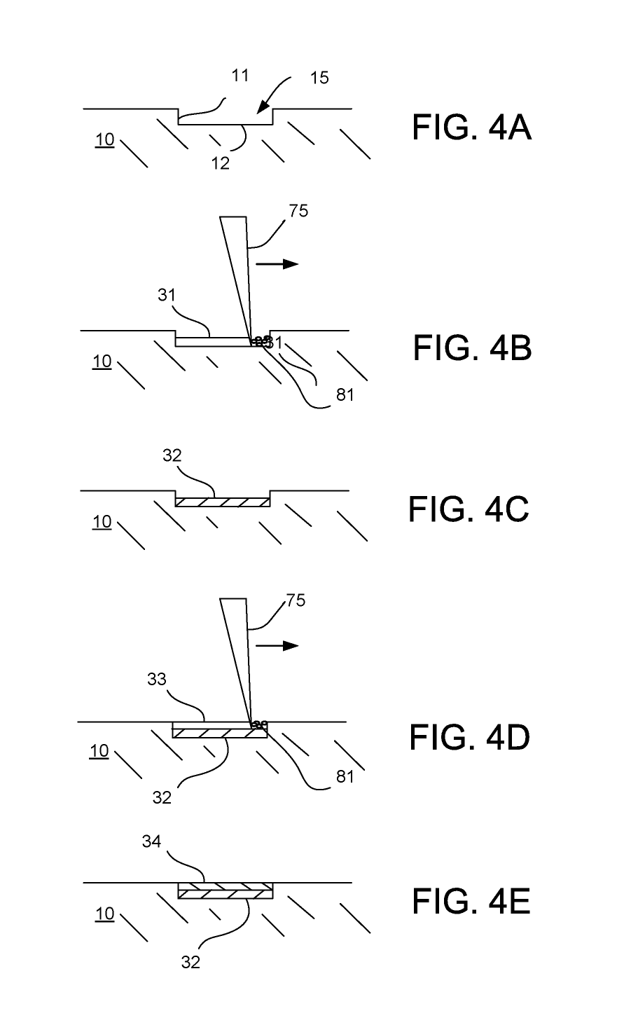

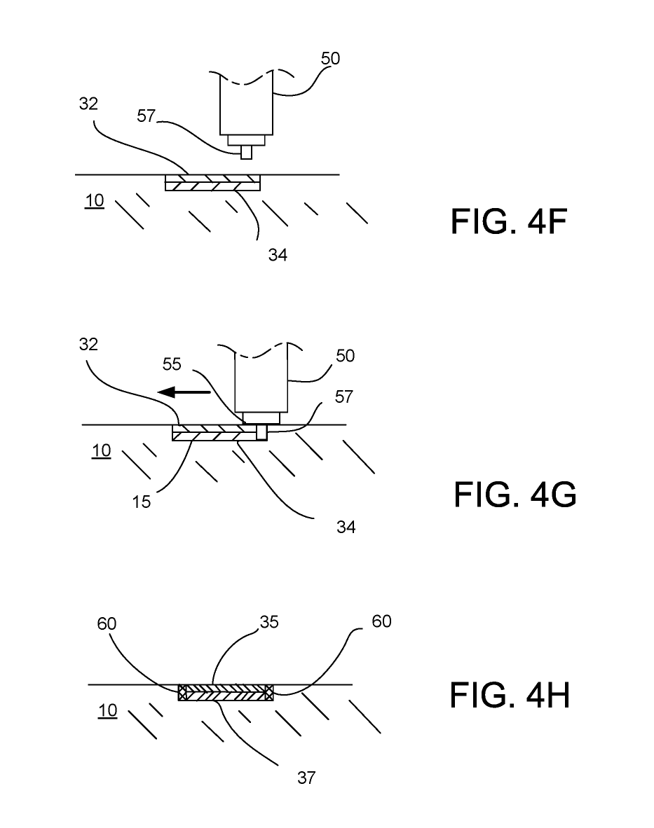

FIGS. 4A-4H illustrate a schematic of a method according to an example embodiment. FIG. 4A shows a removal of material of the component to form a cavity. FIGS. 4B-4E show depositions of additive materials onto the component. FIG. 4F shows a subsequent friction stir processing using a friction stir tool. FIG. 4G illustrates the deposited additive materials after the friction stir processing. FIG. 4H illustrates a microstructure of the deposited additive materials.

FIG. 4A shows a removal of material of the component to form a cavity. It is noted that FIG. 4A is similar to FIG. 3B.

Referring to FIG. 4A, a portion of material in the component 10, around where the defect has occurred, is removed to create a cavity 15. The cavity can have the sidewall 11 and the bottom surface 12. Removal of the material around the defect area in the component can avoid and/or reduce the potential for, for example, oxide or some other contaminant to mix into the base metal during the repair.

FIGS. 4B and 4C depict an exemplary embodiment of an additive manufacturing process.

In some implementations, in FIG. 4B, a laser deposition process is shown, where a deposit layer 31 may be formed inside of the cavity 15. During the additive manufacturing process, an energy source (e.g., laser) may selectively direct an energy beam 75 toward a powder particles 81 (i.e., additive material) to heat the power particles to form the deposit layer 31. The deposit layer 31 may be spread evenly across the surface inside the cavity 15. In some implementations, the deposit layer 31 may be formed in a left to right direction as shown in FIG. 4B.

In some implementations, the energy beam 75 may sinter the powder particles 81 together as part of a selective sintering process. In another implementation, the energy beam 75 may melt the powder particles 81 together into a melt pool which then may solidify to form the deposit layer 31.

In some implementations, the selective laser deposition process may be performed using a set of parameters. The process parameters may include powder-related parameters, such as a particle size, and a layer thickness, etc. The size of the powder particles may be varied for an entire layer or it may be varied locally within a layer. For example, finer powder particles may require less energy to heat, while larger particle size may require more heat. Particle size may then be varied to match local heating requirements needed to relieve the defect, i.e., local residual stress.

In some implementations, these process parameters may also include laser-related parameters such as a direction of energy beam, energy beam intensity, energy beam diameter, energy beam traversal rate (across the cavity). In some implementations, in the case of a pulse-laser, the laser characteristics may include pulse characteristics such as frequency and duration etc. In addition, the laser path taken when forming the deposit layer 31 may vary. For example, instead of following a path from one end to another end of the deposited layer to form the deposit layer 31, the energy beam 75 may jump around from one location to another remote location in the deposit layer 31. In such an instance, the energy beam 75 may first process a location(s) in a manner effective to relieve residual stress that has been detected, and then process to the remainder of the location(s) to form the deposit layer 31.

As shown in FIG. 4C, the solidified deposit layer 31 is formed in the cavity 15, defining a first additive material 32.

FIGS. 4D and 4E depict an exemplary embodiment of a subsequent additive manufacturing process. The subsequent additive manufacturing process as shown in FIG. 4D is similar to the additive manufacturing process as shown in FIG. 4B.

In some implementations, a deposit layer 33 may be formed on the first additive material 32 inside of the cavity 15. Similarly, the energy source (e.g., laser) may selectively direct the energy beam 75 toward the powder particles 81 (i.e., additive material) to heat the power particles to form the deposit layer 33. The deposit layer 33 may be spread evenly across the surface of the first additive material 32 inside of the cavity 15. In some implementations, the deposit layer 33 may be formed in a left to right direction as shown in FIG. 4D.

As shown in FIG. 4E, the solidified deposit layer 33 may be formed in the cavity 15, defining a second additive material 34. The second additive material 34 may be layered on the first additive material 32. In other words, the second additive material 34 and the previously formed first additive material 32 constitute a stacked layer.

In some implementations, there may be more than two layers constituting the stacked additive materials. For example, additional layers may be applied in a similar manner as above until a desired additive material thickness is achieved.

In some implementations, the first additive material 32 and the second additive material 34 may be of a similar or dissimilar material.

In some implementations, the first additive material 32 and the second additive material 34 may be of a similar or dissimilar material as that of the material of the component 10.

FIG. 4F shows the subsequent friction stir processing used to ensure metallurgical bonding between the component 10 and the deposited first additive material 32 and the deposited second additive material 34.

As shown in FIG. 4F, once an entire cross-sectional layer of the second additive material 34 is deposited in the cavity 15, the first additive material 32 and the second additive material 34 in the cavity 15 may be mixed. In some implementation, the mixing may be FSP using the friction stir tool 50 to homogenize the deposited first additive material 32 and the deposited second additive material 34, and promote interlayer adhesion with the material of the component 10. In addition, the FSP will refine the microstructure of the deposited first additive material 32 and the deposited second additive material 34.

In some implementations, the depth of the pin 57 in the deposited first additive material 32 and the deposited second additive material 34 can vary depending on the depth of the cavity 15. In the implementation shown in FIG. 4G, the length of the pin 57 is matched to the depth of the cavity 15.

Further discussion of the friction stir tool 50 will not be described herein as FIG. 4F is similar to FIG. 3D.

As shown in FIG. 4G, around a perimeter 60 (i.e., sidewalls in the cavity) of the cavity 15, the materials of the first additive material 32, the second additive material 34, and/or the material of the component 10 may be mixed to form a good adhesion property. Because there is a metallurgical bonding between the deposited first additive material 32, the deposited second additive material 34, and the component 10, a promotion of interlayer adhesion between the materials are provided.

Similarly, due to FSP, as shown in FIG. 4H, the microstructure of the deposited first additive material 32 and the deposited second additive material 34 (around the perimeter of the cavity) have been refined or mixed into mixed additive materials (i.e., mixed first additive material 35 and mixed second additive material 37, respectively).

In some implementations, the mixing may occur between the first additive material 32, the second additive material 34, and the material of the component 10, or any combinations thereof.

In some implementations, the mixing of the first additive material 32, the second additive material 34, and the material of the component 10 may occur at a bottom region of the cavity 15.

FIG. 5 is a schematic drawing of the friction stir tool 50 according to at least one example embodiment. FIG. 5 illustrates the friction stir tool 50 being used in a friction stir processing method by mixing the deposited additive material 30 in the cavity 15 to promote interlayer adhesion with the material of the component 10.

In some implementations, the friction stir tool 50 may include at least a shank 53, a shoulder 55 and a pin 57 extending outward from the shoulder 55. The pin 57 may be rotated against the additive material 30 and/or the component 10 until sufficient heat is generated, at which point the pin 57 of the friction stir tool 50 may be plunged into the plasticized additive material 30. In some implementations, the pin 57 may be plunged into the additive material 30 until reaching the shoulder 55 which prevents further penetration into the component 10. In some implementations, the pin 57 may be plunged into the additive material 30 where the cavity 15 of the component 10 is located.

In some implementations, when the shoulder 55 contacts the surface of the additive material 30, its rotation creates additional frictional heat that plasticizes the material around the inserted pin 57. The shoulder 55 may provide a forging force that contains the upward metal flow caused by the rotating tool pin 57.

During the friction stir processing method, the area to be processed and the friction stir tool 50 may be moved relative to each other such that the friction stir tool 50 traverses a desired direction. The rotating friction stir tool 50 provides a continual hot working action, plasticizing metal within a narrow zone as it moves transversely along the component 10 (within the cavity 15), while transporting metal from the leading edge of the pin 57 to its trailing edge. As a processed region cools, there is typically no solidification as no liquid is created as the friction stir tool 50 passes. It is often the case, but not always, that the resulting processed region is a defect-free, recrystallized, fine grain microstructure formed in the area of the processed region (e.g., weld).

As shown in FIG. 5, around the perimeter 60 of the cavity 15, the additive material 30 and the material of the component 10 are mixed into mixed additive material 31. Due to the mixture, the additive material 30 and the component material 10 are consolidated and bonded together. In some implementations, the mixed additive material 31 may be a homogenous mixture with a bond strength approaching the ultimate tensile strength of the material of the component 10.

The friction stir tool 50 may move within or around a boundary (perimeter) of the cavity 15 while the shoulder 55 is pressed against the additive material 30 and/or the material of the component 10. During movement, the rotational movement of the pin 57 creates a pressure difference between the forward region of the friction stir tool 50 and its back side so that plasticized material is moved about the pin 57, and mixes the additive material 30 with the material of the component 10. This creates the mixed additive material 31.

In some implementations, travel speeds of the friction stir tool 50 may change depending upon the specific type of friction stir operation being performed, the application and the material being processed. In some implementations, examples of travel speeds are over 1 m/min with rotation rates of 50 to 8000 rpm. These rates are only examples and should not be considered to be limiting the operation of example embodiments. In some implementations, temperatures reached are usually close to, but below, solidus temperatures. For example, friction stir processing method parameters are a function of a material's thermal properties, high temperature flow stress and penetration depth.

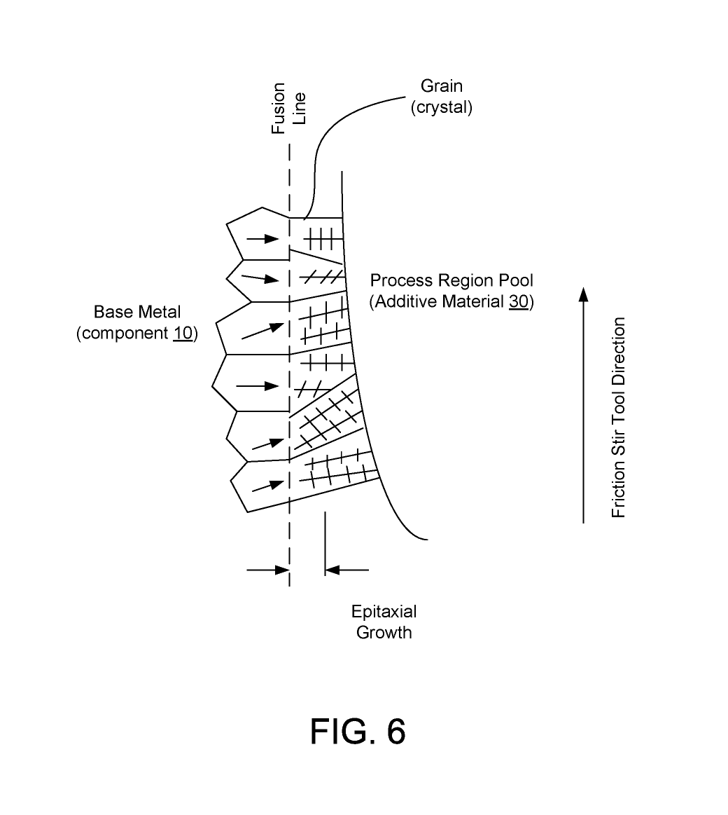

FIG. 6 is a schematic drawing associated with a fine grain microstructure of the additive material according to at least one example embodiment. More specifically, FIG. 6 illustrates an exemplary solidification process of the additive material 30 at a fusion zone of the additive material 30 and the material of the component 10.

Referring to FIG. 6, in some implementations, the additive material 30 may be liquid metal, defining a process region pool. The liquid metal may be poured into the cavity 15 of the component 10, which may then transform or solidify into a solid or desired shape. During solidification of the liquid metal, there may be nucleation and growth of the material. In nucleation, there may be creation of tiny, stable, solid crystals called nuclei in the liquid metal when the temperature of the melt cools down below its equilibrium temperature. Once nuclei have been created, solidification proceeds by growing the nuclei into grains.

When forming the mixed additive material, the heat from a heat source may cause the cold-worked base component 10 to recrystallize in a heat-affected zone surrounding the additive material. In some implementations, columnar grains may grow in the direction of a thermal gradient produced by the moving heat source (e.g., friction stir tool). The grains may grow epitaxially from the base metal (component 10) toward the heat source. Because the direction of maximum temperature gradient is constantly changing from approximately 90°, the grain grows towards the heat source.

In some implementation, the size of the columnar grains increased toward a fusion line. This is the result of epitaxial solidification, which grows toward the center in a direction along the maximum thermal gradient.

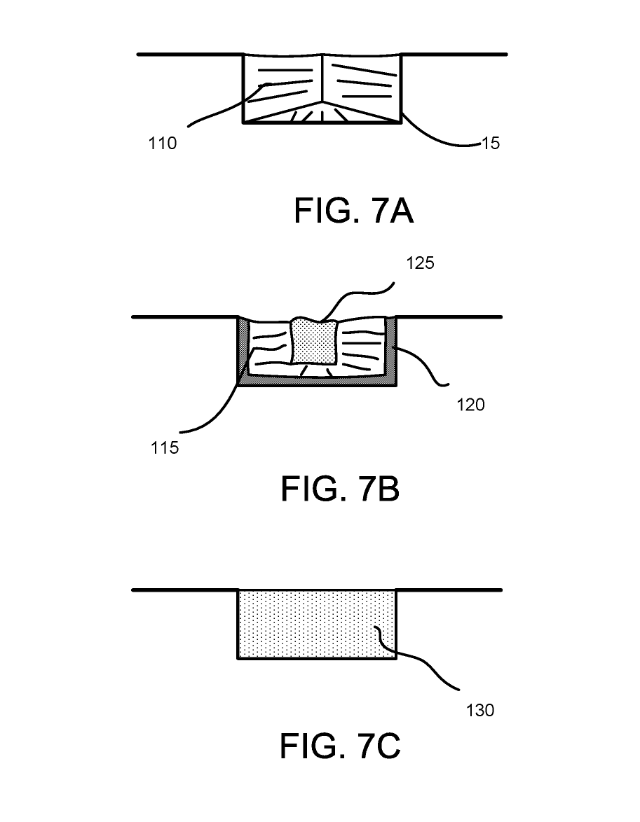

FIGS. 7A-7C are schematic drawings associated with fine grain microstructure according to at least one example embodiment. FIG. 7A illustrates columnar grains after filling the additive material 30 in the cavity 15. FIG. 7A illustrates the columnar grains during the mixing process in the FSP. FIG. 7C illustrates the columnar grains after the additive material 30 has been fully mixed with the material of the component 10.

As shown in FIG. 7A, the microstructure of the additive material 30 may include long columnar grains 110 growing perpendicular to the sidewalls and the bottom of the cavity 15. During metal solidification, grains tend to grow perpendicular to a pool boundary along a maximum temperature gradient.

As shown in FIG. 7B, during the mixing procedure, the microstructure of the additive material 30 may include columnar grains 115 and equiaxed grains (small equiaxed grains 120 and large equiaxed grains 125). The small equiaxed grains 120 may be formed around the sidewalls and bottom surface of cavity 15. The large equiaxed grains 125 may be formed generally in a central region of the cavity 15. The columnar grains 115 may be provided between the small equiaxed grains 120 and the large equiaxed grains 125. As compared to the columnar grains 110 shown in FIG. 7A, the columnar grains 115 are smaller (due to epitaxial growth).

As shown in FIG. 7C, after the mixed procedure, the microstructure of the mixed additive material 31 may include equiaxed grains 130. In other words, there are only equiaxed grains 130 and no columnar grains present in the mixed additive material 31. The columnar grains have been transitioned into equiaxed grains since nucleation of equiaxed grains occurs in the liquid ahead of the columnar zone. This equiaxed structure (i.e., mixed additive material 31) tend to reduce solidification cracking and improve mechanical properties such as strength, ductility and toughness, of the material.

In some implementations, the non-destructive processed region inspection may be assessed for acceptability and if unacceptable, action may be taken, such as a change in the additive manufacturing process to alleviate or compensate for defects (e.g., residual stress). In the instance of a found defect, the additive manufacturing process may be halted to either to finish the part, or to scrap the part.

In some implementations, the non-destructive processed region inspection may be performed on the most recently formed deposited additive material 30 where it may be in a solid state. For example, the x-ray examination may be performed after the entire most recently formed solid deposited additive material 30 has been formed and cooled to ambient temperature. In some implementations, the x-ray examination may be performed immediately after the powder 81 has been treated with the laser, in which case the material being processed will be relatively warm. In the case of selective laser melting, the material may be near its melting temperature. Since characteristics and an amount of residual stress changes as a material cools, the residual stress detected in the latter instance is not the same as it will be once the component is complete and at ambient temperature.

In some implementation, the non-destructive processed region inspection may be performed soon after the laser treatment is completed. This may also allow for less drastic corrective action that may pre-empt the formation of the residual stress predicted to form during the cooling subsequent to the x-ray process.

In some implementations, the non-destructive processed region inspection may occur as often as every time a solid deposited additive material is formed. Alternately, the non-destructive processed region inspectionmay occur at predetermined intervals, such as every other solid deposited additive material.

In some implementations, the non-destructive processed region inspection may occur after the FSP has concluded. For example, the non-destructive processed region inspection may be performed after the friction stir tool 50 has processed (mixed) the additive material with the material of the component.

In some implementations, in solidification of metal, there are two types of grain: columnar and equiaxed. For example, after nucleation of crystal in an undercooled isothermal melt, growth is generally equiaxed, i.e., it proceeds equally in all directions including heat flux. Alternatively, columnar is when the heat flux is unidirectionally oriented (at least locally). For equixed growth, the heat flows from the crystal into the undercooled melt, and for columnar growth, the heat flows from the superheated melt into the cooler solid. Further, in equiaxed growth, the solid-liquid interface may be unstable leading in single phase solidification to dendritic grains, while in columnar growth, one may grow planar cellular. A transition from columnar to equiaxed growth takes place when nucleation of equiaxed grains occurs in the liquid ahead of the columnar zone.

In some implementations, the additive material is deposited on the component in nanocrystalline form. After the additive material has been friction stirred, the nanocrystalline structure of the additive material may be maintained. As used herein, the term nanocrystalline means a material in which the average crystal grain size is less than 0.5 micron, typically less than 100 nanometers. Due to the fact that the friction stirring process is carried out at a relatively low temperature below the melting point of the additive material, little or no crystal grain growth may occur during the friction stirring process.

In some implementations, the additive material may include a metal matrix composite (MMC). As used herein, the term MMC means a material having a continuous metallic phase having another discontinuous phase dispersed therein. The metal matrix may include a pure metal, metal alloy or intermetallic.

In some implementations, MIG welding, sometimes referred to as gas metal arc welding (GMAW) may be a welding process that uses heat generated by an electric arc to fuse the metal and a workpiece metal. The basic principle of MIG welding is, an arc is maintained between an end of the wire electrode and the component where the heat source required to melt the material is obtained. The arc may melt the end of the electrode wire, which may be transferred to a molten weld pool. For a given wire material and diameter, the arc current may be determined by the wire feed rate. The arc and the weld pool may be shielded from atmospheric contamination by an externally supplied shield of inert (non-reactive) gas. The MIG process may be suited to a variety of applications provided the shielding gas, electrode (wire) size and welding parameters have been correctly set. Welding parameters include the voltage, travel speed, arc (stick-out) length and wire feed rate. The arc voltage and wire feed rate will determine the filler metal transfer method.

In some implementations, TIG welding, sometimes referred to as gas tungsten arc welding (GTAW) may be a welding process in which it uses electrode primarily made of tungsten and inert gas for shielding the weld pool to prevent contamination from atmospheric gases alloys. The weld area may be protected from atmospheric contamination by an inert shielding gas (e.g., argon or helium), and a filler material may be normally used. A constant-current welding power supply may produce electrical energy, which may be conducted across the arc through a column of highly ionized gas and metal vapors known as plasma.

In some implementations, laser deposition may be a welding process in which metal powder is injected into a focused beam of a high-power energy source (i.e., laser) under tightly controlled atmospheric conditions. The focused energy beam may melt the surface of the target material and may generate a small molten pool of base material. Powder delivered into this same spot may be absorbed into the melt pool, thus generating a deposit. The resulting deposits may then be used to build or repair metal parts for a variety of different applications.

Method steps may be performed by an automated welder, which may include one or more programmable processors executing a computer program to perform functions by operating on input data and generating output. Method steps also may be performed by, and an apparatus may be implemented as, special-purpose logic circuitry (e.g., an FPGA (field programmable gate array) or an ASIC (application-specific integrated circuit)).

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. Various implementations of the systems and techniques described here can be realized as and/or generally be referred to herein as a controller, a circuit, a module, a block, or a system that can combine software and hardware aspects. For example, a module may include the functions/acts/computer program instructions executing on a processor (e.g., a processor formed on a silicon substrate, a GaAs substrate, and the like) or some other programmable data processing apparatus.

Some of the above example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional blocks not included in the figure. The processes may correspond to methods, functions, procedures, subroutines, subprograms, etc.

Specific structural and functional details disclosed herein are merely representative for purposes of describing example embodiments. Example embodiments, however, may be embodied in many alternate forms and should not be construed as limited to only the embodiments set forth herein.

The terminology used herein is for the purpose of describing particular embodiments only and is not intended to be limiting of the embodiments. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of the stated features, steps, operations, elements, and/or components, but do not preclude the presence or addition of one or more other features, steps, operations, elements, components, and/or groups thereof.

It will be understood that when an element is referred to as being “coupled,” “connected,” or “responsive” to, or “on,” another element, it can be directly coupled, connected, or responsive to, or on, the other element, or intervening elements may also be present. In contrast, when an element is referred to as being “directly coupled,” “directly connected,” or “directly responsive” to, or “directly on,” another element, there are no intervening elements present. As used herein the term “and/or” includes any and all combinations of one or more of the associated listed items.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein may be interpreted accordingly.

Example embodiments of the present inventive concepts are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments of the present inventive concepts should not be construed as limited to the particular shapes of regions illustrated herein but are to include deviations in shapes that result, for example, from manufacturing. Accordingly, the regions illustrated in the figures are schematic in nature and their shapes are not intended to illustrate the actual shape of a region of a device and are not intended to limit the scope of example embodiments.

It will be understood that although the terms “first,” “second,” etc. may be used herein to describe various elements, these elements should not be limited by these terms. These terms are only used to distinguish one element from another. Thus, a “first” element could be termed a “second” element without departing from the teachings of the present embodiments.

Unless otherwise defined, all terms (including technical and scientific terms) used herein have the same meaning as commonly understood by one of ordinary skill in the art to which this present inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

While certain features of the described implementations have been illustrated as described herein, many modifications, substitutions, changes, and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components, and/or features of the different implementations described.

What is claimed is:

1. A method, comprising:
filling at least a portion of a cavity of a component with an additive material, the additive material including a liquid metal or a solid metal; and
mixing, using a friction stir tool, a material of the component with the additive material.

2. The method of claim 1, wherein mixing of the material of the component and the additive material is performed around a perimeter of the cavity.

3. The method of claim 1, wherein the mixing occurs along at least one of sidewalls of the cavity and bottom wall of the cavity.

4. The method of claim 1, wherein filling the cavity is performed by partially filling the cavity with the additive material.

5. The method of claim 1, wherein the additive material includes a first additive material, wherein a second additive material is layered on the first additive material.

6. The method of claim 1, further comprising:
removing a portion of the component to define the cavity.

7. The method of claim 6, wherein the removal of the portion of the component is performed prior to filling the cavity with the additive material.

8. The method of claim 1, wherein a material of the liquid metal or solid metal is same as the material of the component.

9. The method of claim 1, wherein a material of the liquid metal or solid metal is at least one of steel, Al, Ni, Cr, Cu, Co, Au, Ag, Mg, Cd, Pb, Pt, Ti, Zn, Fe, Nb, Ta, Mo, and W.

10. The method of claim 10, wherein the liquid metal or solid metal is a combination of metals including Al, Ni, Cr, Cu, Co, Au, Ag, Mg, Cd, Pb, Pt, Ti, Zn, Fe, Nb, Ta, Mo, and W.

11. The method of claim 1, wherein filling the cavity with the additive material is performed by at least one of metal inert gas welding, tungsten inert gas welding, laser deposition, powder deposition, and powder infiltration.

12. A method, comprising:
removing a portion of a component to define a cavity within the component;
filling the cavity with an additive material, the additive material including a liquid metal or a solid metal; and
mixing, using a friction stir tool, a material of the component with the additive material.

13. The method of claim 12, wherein the cavity is at least one of a notch, a set of notches, a hole, and a series of holes.

14. The method of claim 12, wherein a material of the liquid metal or solid metal is same as the material of the component.

15. The method of claim 12, wherein a material of the liquid metal or solid metal is at least one of steel, Al, Ni, Cr, Cu, Co, Au, Ag, Mg, Cd, Pb, Pt, Ti, Zn, Fe, Nb, Ta, Mo, and W.

16. The method of claim 12, wherein the liquid metal or solid metal is a combination of metals including Al, Ni, Cr, Cu, Co, Au, Ag, Mg, Cd, Pb, Pt, Ti, Zn, Fe, Nb, Ta, Mo, and W.

17. The method of claim 12, wherein filling the cavity with the additive material is performed by at least one of metal inert gas welding, tungsten inert gas welding, laser deposition, powder deposition, or nd powder infiltration.

18. A product, comprising:
an additive material filled in a cavity of a component, the additive material including at least one of a liquid metal or a solid metal; and
a mixture, composed of a material of the component and the additive material, formed around a perimeter of the cavity.

19. The product according to claim 18, wherein the mixture is formed by a friction stir tool.

20. The product according to claim 18, wherein the additive material is formed by at least one of metal inert gas welding, tungsten inert gas welding, laser deposition, powder deposition, or powder infiltration.
